(19) United States
(12) Patent Application Publication
(10) Pub. No.: US 2022/0284374 A1
(43) Pub. Date: Sep. 8, 2022

(54) SKILLS GAP MANAGEMENT PLATFORM

(71) Applicant: Accenture Global Solutions Limited, Dublin (IE)

(72) Inventors: Diarmuid John CAHALANE, Co Cork (IE); Patrick MOREAU, Dublin (IE)

(21) Appl. No.: 17/190,637

(22) Filed: Mar. 3, 2021

(51) Int. Cl. G06Q 10/06; G06F 16/901; G06Q 10/10; G06Q 50/20; G09B 19/00

(52) U.S. Cl. CPC G06Q 10/06398; G06F 16/9024; G06Q 10/063112; G06Q 10/1053; G06Q 50/2057; G09B 19/00

(57) ABSTRACT

In some implementations, a device may receive a set of role skills data that identifies one or more role skills associated with a role, a set of worker skills data that identifies one or more worker skills associated with a worker, and a set of skill proximity data that identifies one or more proximity values. The device may generate a weighted directed graph comprising a network of a plurality of nodes and a plurality of edges. The device may determine a fitness of a worker for a role based at least in part on performing a comparison of a maximum network flow with a threshold. The device may perform an action based at least in part on determining the fitness of the worker for the role.

### BACKGROUND

In the labor market, the level of demand for a given skill may evolve quickly due to an ever-changing array of technologies being used to address business and/or consumer needs. Skill demands can also shift due to changing business and/or consumer needs. In this context, worker roles and the skills useful for performing those roles effectively are ever-changing. Hiring managers and talent specialists have the difficult job of advising an employer or manager about which workers from internal and external pools of workers may be best suited to hire for, train for, or assign to, a given role.

### SUMMARY

In some implementations, a method includes receiving a set of role skills data that identifies one or more role skills associated with a role; receiving a set of worker skills data that identifies one or more worker skills associated with a worker; receiving a set of skill proximity data that identifies one or more proximity values, wherein a proximity value of the one or more proximity values quantifies a relationship between a first skill of the one or more role skills or the one or more worker skills and a second skill of the one or more role skills or the one or more worker skills; generating a weighted directed graph, comprising a network of a plurality of nodes and a plurality of edges, based at least in part on the set of role skills data, the set of worker skills data, and the set of skill proximity data; determining a plurality of edge utilities corresponding to the plurality of edges in the weighted directed graph; determining, based at least in part on the plurality of edge utilities, a maximum network flow by optimizing a flow on the network from a source node to a target node, wherein the source node represents the role and the target node represents the worker; determining a fitness of the worker for the role based at least in part on performing a comparison of the maximum network flow with a threshold; and performing an action based at least in part on determining the fitness of the worker for the role.

In some implementations, a device includes one or more memories; and one or more processors, communicatively coupled to the one or more memories, configured to: receive a set of role skills data that identifies one or more role skills associated with a role; receive a set of worker skills data that identifies one or more worker skills associated with a worker; receive a set of skill proximity data that identifies one or more proximity values, wherein a proximity value of the one or more proximity values quantifies a relationship between a first skill of the one or more role skills or the one or more worker skills and a second skill of the one or more role skills or the one or more worker skills; generate a weighted directed graph, comprising a network of a plurality of nodes and a plurality of edges, based at least in part on the set of role skills data, the set of worker skills data, and the set of skill proximity data; determine a plurality of edge utilities corresponding to the plurality of edges in the weighted directed graph; determine, based at least in part on the plurality of edge utilities, a maximum network flow by optimizing a flow on the network from a source node to a target node, wherein the source node represents the role and the target node represents the worker; determine a fitness of the worker for the role based at least in part on performing a comparison of the maximum network flow with a threshold; and perform an action based at least in part on determining the fitness of the worker for the role.

In some implementations, a non-transitory computer-readable medium storing a set of instructions includes one or more instructions that, when executed by one or more processors of a device, cause the device to: receive a set of role skills data that identifies one or more role skills associated with a role; receive a set of worker skills data that identifies one or more worker skills associated with a worker; receive a set of skill proximity data that identifies one or more proximity values, wherein a proximity value of the one or more proximity values quantifies a relationship between a first skill of the one or more role skills or the one or more worker skills and a second skill of the one or more role skills or the one or more worker skills; generate a weighted directed graph, comprising a network of a plurality of nodes and a plurality of edges, based at least in part on the set of role skills data, the set of worker skills data, and the set of skill proximity data; determine a plurality of edge utilities corresponding to the plurality of edges in the weighted directed graph; determine, based at least in part on the plurality of edge utilities, a maximum network flow by optimizing a flow on the network from a source node to a target node, wherein the source node represents the role and the target node represents the worker; determine a fitness of the worker for the role based at least in part on performing a comparison of the maximum network flow with a threshold; and perform an action based at least in part on determining the fitness of the worker for the role.

### BRIEF DESCRIPTION OF THE DRAWINGS

FIG. 1 is a diagram of an example implementation described herein.

FIG. 2 is a diagram of an implementation of a visual representation of an example weighted directed graph for use with an example implementation.

FIGS. 3A and 3B are diagrams of an implementation of a visual representation of an example weighted directed graph for use with an example implementation.

FIG. 4 is a diagram of an example environment in which systems and/or methods described herein may be implemented.

FIG. 5 is a diagram of example components of one or more devices of FIG. 1.

FIG. 6 is a flowchart of an example process relating to skills gap management platforms.

### DETAILED DESCRIPTION

The following detailed description of example implementations refers to the accompanying drawings. The same reference numbers in different drawings may identify the same or similar elements.

An important component of assessing a worker's fitness for a role is the degree to which the skills held by a worker equip the worker to take up and carry on the role. The fragmentation and dynamism of roles and skills make it difficult for an expert to stay sufficiently well-informed of the myriad skills (often of a domain specific, technical, and nuanced character) and their relationships so as to be able to advise on a given worker's skills fit to a role. In that context, implementations of the subject matter disclosed herein provide an automated system that processes large volumes of data to take due account of pertinent relationships and their strengths in producing output which may facilitate making a decision or which may automatically initiate a learning action to address an identified skills gap.

When assigning workers to roles or to skills training for roles, it is important to consider the skills required to perform the role (as may be listed in the role description) and the skills each worker holds (as may be enumerated in the worker's resume). A skill required or useful for performing a role may be referred to as a “role skill.” A skill that a worker possesses (e.g., as indicated in the worker's resume) may be referred to as a “worker skill.” Based on data associated with role skills and worker skills, a “skills fit” may be determined as a numerical score. The production of such a numerical score may be useful, for example, for the selection or rank ordering of workers for work and training assignments. Where a worker's resume does not show high proficiency in all of the skills in a role description, it may be desirable to also identify which role skills are lacking, such that training can be selected to alleviate the gap. Because skills may be related, and in some cases at least partially substitutable, two difficulties may arise, among others.

The first difficulty may be associated with assigning partial credit in the calculation of the skills fit score based on substitutable or related skills. For example, a worker may be able to perform the role by using a skill on their resume, but which is not in the job description, with some fraction of the utility, efficiency and/or quality with which another worker may be able to perform the role by using a skill that is in the job description. As there may be some tolerance for variability in the degree of the utility, efficiency, and/or quality that is acceptable, it may be helpful to be able to quantify this sort of variance. In some cases, a worker with a worker skill that is closely related to a skill associated with the role may be able to quickly acquire the role skill and/or perform the role if provided with some type of assistance. Training a worker to acquire a new skill may be more cost effective, and/or productive than hiring a new worker who already has that skill. However, skills assessment systems often are not able to identify such workers.

The other difficulty that may arise is associated with accounting for the redundancy of one or more related worker skills and quantifying the extent to which those skills may be relevant to role skills (in their own right or by relatedness). For example, a skills fit calculation may be inflated where worker skills are redundant in their utility in the context of the role due to their relatedness or substitutability. A worker who could use any of two or more worker skills to perform the role may not be twice as valuable in the role as a worker who can carry out the same role with one skill. Other considerations that may influence the quantification, where such information is available, include the relative importance of the various skills in the role description to the carrying out of the role, and/or the worker's proficiency in each of the worker skills, among other examples.

Implementations of the subject matter disclosed herein may include a skills fit system that produces a numerical score to convey a quality of fit (which may be referred to as a “fitness”) of a worker to a role based at least in part on a set of worker skills and a set of role skills, while taking into account relatedness of skills and redundancy of related skills, among other examples. In some implementations the skills fit system may identify skills gaps and automatically suggest or initiate learning actions (e.g., educational software, programs, modules), which may include role skills that represent gaps in terms of the worker's ability to fill the role by leveraging those skills or related or substitutable worker skills instead.

According to some implementations, for example, the system may construct a directed graph, G(V,E), of nodes (V) and edges (E), based at least in part on received role skills data, worker skills data, and skill proximity data. Skill proximity data is data that characterizes the relatedness and/or substitutability of respective pairs of role and worker skills. The directed graph may be a weighted graph. For example, the system may map edge weights W(E) to the edges E in the graph G(V,E) to account for the relative importance of role skills, the relatedness of worker skills to the role skills, skill relatedness, and/or worker skill proximity, among other examples. A node may be referred to, interchangeably, as a vertex. An edge may be referred to, interchangeably, as a link. An edge weight may be referred to, interchangeably, as a weight, a capacity, or a utility. A path may be a sequence of one or more edges. For example, a path may be a sequence of a plurality of edges that connect a source node (e.g., a role node) to a target node (e.g., a worker node).

The system may be configured to determine a maximum network flow of the weighted directed graph. The maximum network flow (often referred to, interchangeably, as “max flow,” “optimal flow,” or“optimized flow”) may be determined using a maximum flow algorithm. The system may generate the weighted directed graph by representing the role by instantiating a source node (e.g., role node) and representing the worker by instantiating a target node (e.g., worker node). The system may instantiate one or more role skill nodes, each representing a role skill, and one or more worker skill nodes, each representing a worker. The system may calculate the maximum flow afforded by the graph subject to W(E) constraining the max flow on a given edge. The calculated maximum flow on the graph may function as the score for the overall quality of the worker's skills fit to the role (e.g., the fitness of the worker for the role).

The system also may be configured to identify one or more skills gaps. A skills gap may refer to a skill that, if improved by the worker, may result in a greater fitness of the worker for the role. To identify skills gaps, the system may determine an edge flow associated with an edge connecting the source node to a role skill node. The system may determine a ratio of the edge flow to the edge capacity of the edge. The system may perform a comparison between the ratio and a skills threshold. The system may identify a skills gap based at least in part on the comparison. In some implementations, the system may facilitate initiation of a learning action associated with the skills gap.

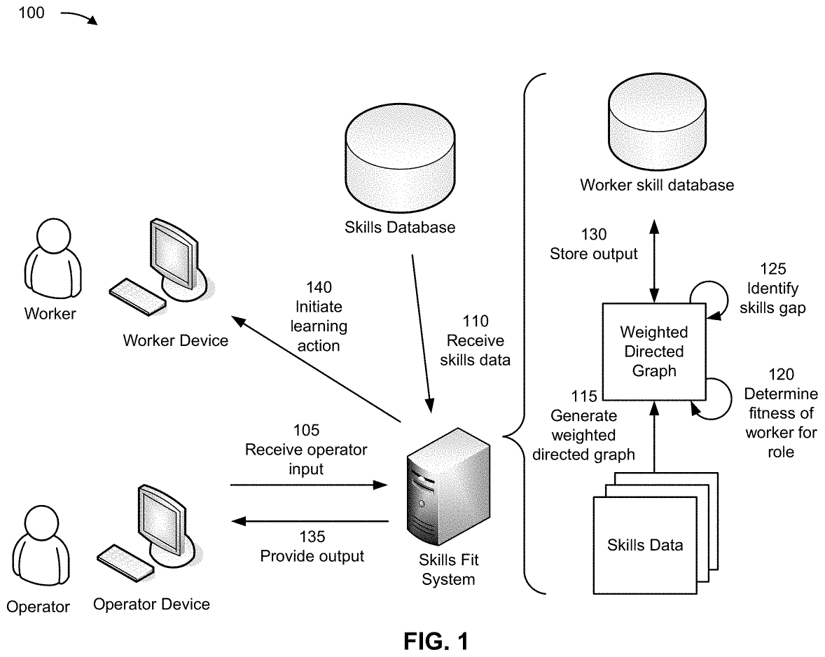

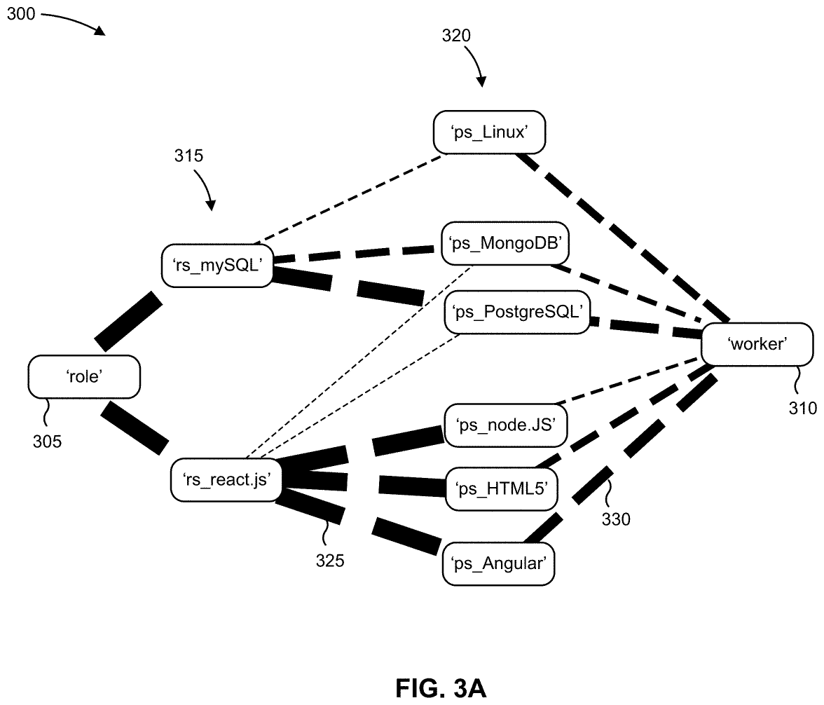

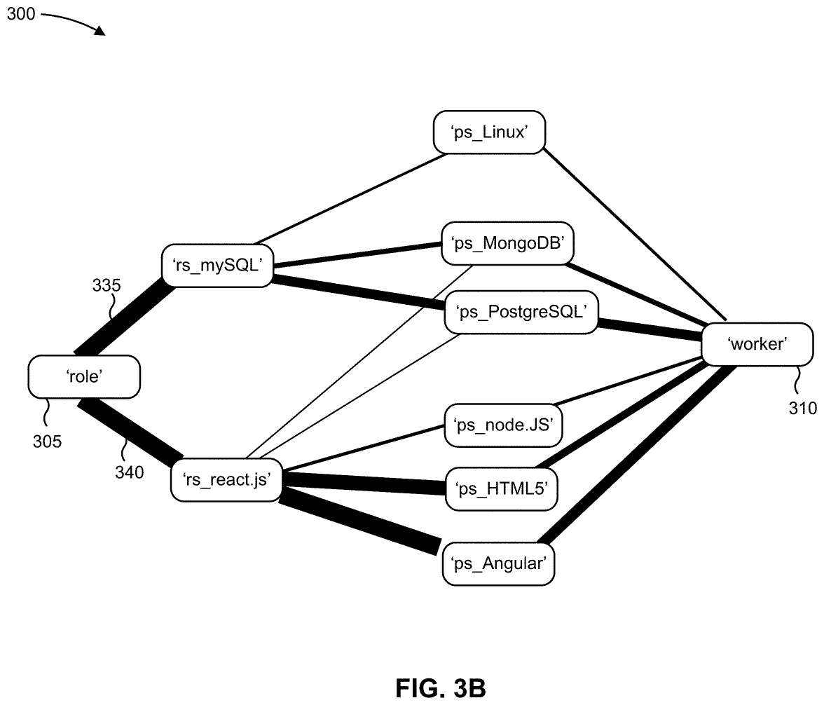

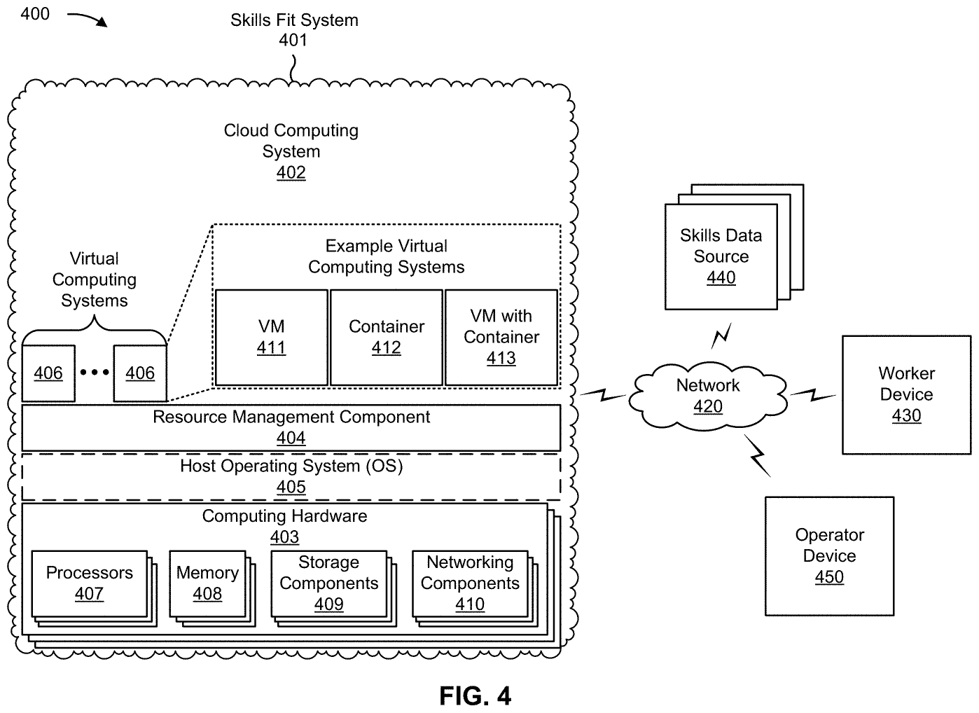

FIG. 1 is a diagram of an example implementation 100 associated with a skills fit management platform. As shown in FIG. 1, example implementation 100 includes a skills fit system, an operator device, and a worker device. These devices are described in more detail below in connection with FIG. 3 and FIG. 4.

As shown by reference number 105, the skills fit system may receive operator input. The operator input may be provided by an operator (e.g., through an operator device) to initiate one or more aspects of the system described herein. The operator may be an employer, supervisor, employment specialist, and/or the like. The operator may provide input to the skills fit system to initiate a procedure to identify skills gaps, for example.

As shown by reference number 110, the skills fit system may receive skills data. The skills fit system may receive the skills data from a skills database, as shown. Some or all of the skills data may be received from the skills database, the worker device, and/or the operator device. The skills data may include, for example, a set of role skills data that identifies one or more role skills associated with a role. The set of role skills data also may identify a relative importance, to performing the role, of a skill of the one or more skills associated with the role.

The skills data may include a set of worker skills data that identifies one or more worker skills associated with a worker. The set of worker skills data also may identify a proficiency level corresponding to a skill of the one or more skills associated with the one or more workers. The skills data may include a set of skill proximity data that identifies one or more proximity values. A proximity value of the one or more proximity values may quantify a relationship between a first skill of the one or more role skills or the one or more worker skills and a second skill of the one or more role skills or the one or more worker skills. The proximity value may be based at least in part on a distance metric that characterizes a distance between a vector representation of the role skill and a vector representation of the worker skill.

As shown by reference number 115, the skills fit system may generate a weighted directed graph based at least in part on the set of role skills data, the set of worker skills data, and the set of skill proximity data. The weighted directed graph may include a network of a plurality of nodes and a plurality of edges. The skills fit system may generate the weighted directed graph based at least in part on instantiating a plurality of nodes. The nodes may include a source node that represents the role, a target node that represents the worker, a one or more role skill nodes that represent one or more role skills, and one or more worker skill nodes that represent one or more worker skills. The skills fit system may instantiate a plurality of edges. The plurality of edges may include one or more edges between the source node (e.g., the role node) and the one or more role skill nodes, one or more edges between the one or more role skill nodes and the one or more worker skill nodes, and one or more edges between the one or more worker skill nodes and the target node (e.g., the worker node). The skills fit system may determine an edge utility (capacity or weight) of each edge of the plurality of edges and may map those edge utilities into the graph.

As shown by reference number 120, the skills fit system may determine a fitness of the worker for the role. The fitness may be determined based at least in part on a maximum network flow. The skills fit system may determine the maximum network flow based at least in part on the plurality of edge utilities. For example, in some implementations, the skills fit system may determine the maximum network flow based at least in part on applying a max flow algorithm to the weighted directed graph. In some implementations, the skills fit system may determine a fitness of the worker for the role based at least in part on performing a comparison of the maximum network flow with a threshold. A weighted directed graph may be generated for each unique combination of role and worker.

As shown by reference number 125, the skills fit system may identify a skills gap of the worker with respect to the role. For example, the skills fit system may determine an edge flow associated with an edge connecting the source node to a role skill node and may identify a skills gap based at least in part on performing a comparison between a ratio of the edge flow to the corresponding edge capacity and a skills threshold.

In some implementations, the skills fit system may perform an action based at least in part on the determining the fitness of the worker for the particular role and/or based at least in part on identifying a skills gap. For example, as shown by reference number 130, the skills fit system may store output from the weighted directed graph analysis. As shown by reference number 135, the skills fit system may provide output to an operator device.

As shown by reference number 140, the skills fit system may initiate, based at least in part on identifying a skills gap, a learning action associated with the skills gap. The learning action may include an automated educational software module, a computer-based learning system, and/or an award system associated with a learning system, among other examples.

Implementations of the subject matter disclosed herein may include a skills fit system that determines a quality of fit of a worker to a role based at least in part on a set of worker skills and a set of role skills, while taking into account relatedness of skills and redundancy of related skills, among other examples. In some implementations the system may identify skills gaps and automatically suggest or initiate learning actions (e.g., educational software, programs, modules, etc.), which may include role skills that represent gaps in terms of the worker's ability to fulfill the role by leveraging those skills or related or substitutable worker skills instead. As a result, implementations may improve performance of skills fit systems, learning modules, and/or other systems associated with matching roles to workers.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

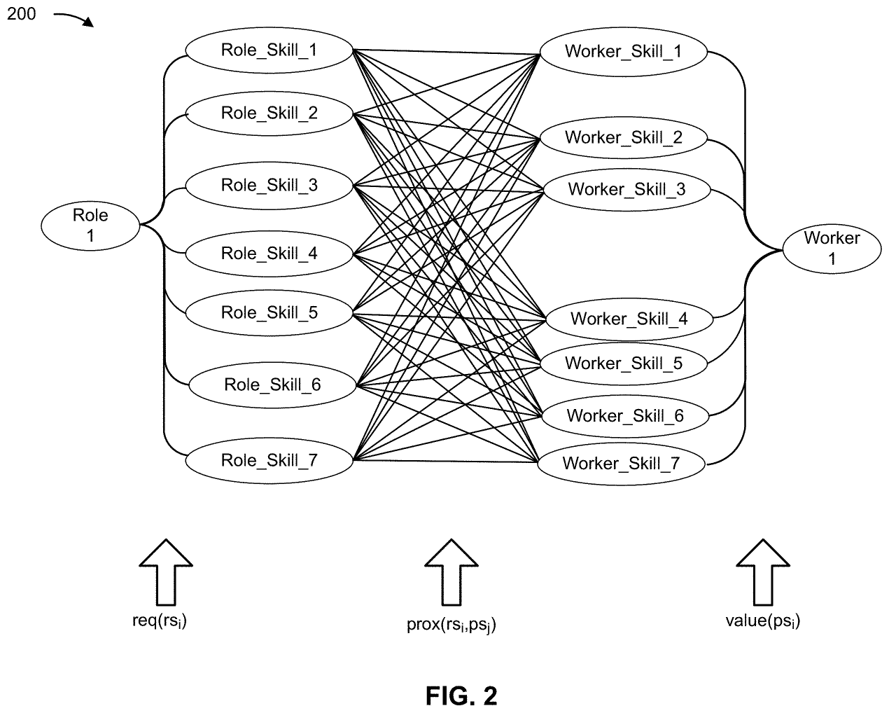

FIG. 2 is a is a diagram of an example visual representation 200 of a weighted directed graph implemented for use with a skills fit system.

In some implementations, for example, for a role/worker pair (shown as “Role1,” and “Worker1”), skills data may be retrieved from a database. The skills data may include a set of role skills data (e.g., skills useful for performing the role) (shown as “Role_Skill_1” through “Role_Skill_7”). If available, the relative importance of the skills to carrying on the role in each case may be retrieved (shown as “req(rsᵢ)”). The skills data also may include a set of worker skills data (e.g., skills that the worker holds) (shown as “Worker_Skill_1” through “Worker_Skill_7”). The skills data also may include data indicating the proficiency, psⱼ, with which the worker holds the skills.

For each distinct pair (Role_Skill_i, Worker_Skill_j), the relatedness of the skills prox(rsᵢ, ps_ⱼ), may be calculated using a distance metric between the skills d(sᵢ, s₁). The distance metric may correspond to a maximum distance dₘₐₓ. The skill distances may be calculated, in some instances, by applying a distance metric to learned vector representations of skills in a skills embedding. For example, in some implementations, the proximity of any given pair of skills, given the distance between the pair d(sᵢ, sⱼ), the max distance between any pair or skills in the global set of skills dₘₐₓ, and a shape parameter λ, may be given by:

$$prox ( {s}_{i} , {s}_{j} ) = {( 1 - \frac{d ( {s}_{i} , {s}_{j} )}{{d}_{max}} )}^{λ} .$$

In some cases, λ may be less than 1, to produce a super-linear fall-off in skill utility with respect to skill proximity.

Based at least in part on the skills data and the calculations above, a weighted directed graph G(V,E) with weights W(E) may be constructed. As shown, a node may be instantiated to represent the role (shown as “Role 1”), and a node may be instantiated to represent the worker (shown as “Worker 1”). For each Role_Skill_i, a node may be instantiated, and for each Person_Skill_i, a node may be instantiated. Weighted edges may be instantiated. For example, a weighted edge may be instantiated between Role1 and each Role_Skill_i, where each weighted edge has a weight req(rsᵢ). A weighted edge may be instantiated between each distinct pair (Role_Skill_i, Worker_Skill_i), having weight prox(rsᵢ, psⱼ), and a weighted edge may be instantiated between each Worker_Skill_i and Worker 1, having weight value(psᵢ).

For example, a formula may be used to calculate each weight of value (psᵢ). In some implementations, for example, the value of a skill in a worker's resume given the worker's proficiency in the skill (which can be set to 1 where proficiency data is not available) and the proximity of other resume skills may be determined by:

$$value ( {ps}_{i} ) = \frac{prof ( {ps}_{i} )}{1 + \sum {{ps}_{j} \neq {ps}_{i}}_{{ps}_{j} ∈ {S}_{k}} prof ( {ps}_{j} ) prox ( {s}_{i} , {s}_{j} )} ,$$

where Sₖ refers to the set of worker skills (e.g., the set of all skills of the worker). The formula may reduce the weight (and hence max flow) for edges corresponding to skills which are in high proximity (redundancy) with other skills. The proficiency reduces both the value and the redundancy impact for skills which are held with lesser proficiency.

In some implementations, a maximum flow (“max flow”) algorithm may be applied to the graph G(V,E), treating the node Role 1 as a source and the node Worker 1 as a target. Any number of different max flow algorithms may be used in accordance with implementations. For example, the Ford-Fulkerson algorithm or a variant thereof may be used. The max flow algorithm may determine the flows on each edge of G(V,E) that maximize the flow from the source to the target subject to the capacities on edges given by the edge weights.

In some implementations, the max flow algorithm may be used to determine a network utility that may be used as a score reflecting the role-worker pair. For identifying skills gaps that indicate skills that the worker might acquire to become more suited to performing role, the skills fit system may identify Role_Skill_i wherever both req(rsᵢ)>req* and the flow through the node Role_Skill_i flow(Role_Skill_i)<role_skill_flow* for some preset threshold requirement level req* and preset threshold flow role_skill_flow*. In some implementations, a similar graph may be constructed for each of a plurality of role/worker pairs. In some implementations, a skills fit system may be configured to display an output determined using the graph, and/or a visual representation of the graph, among other examples.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

FIG. 3A is a diagram of an example visual representation 300 of a weighted directed graph implemented for use with a skills fit system.

To construct the weighted directed graph illustrated by the visual representation 300 in FIG. 3A, a skills fit system may receive skills data. For example, the skills fit system may access a database to obtain role skills data, worker skills data, and/or skill proximity data, among other examples. As an example, the role skills data may be obtained in the form of a table such as table 1, below.

TABLE 1

| Role Skill | Req. Strength |
|---|---|
| rs_react.js | 1 |
| rs_mySQL | 1 |

Worker skills data may be obtained in the form of a table such as table 2, below.

TABLE 2

| WorkerSkill | Proficiency |
|---|---|
| ps_Angular | 0.8 |
| ps_node.JS | 0.3 |
| ps_HTML5 | 0.5 |
| ps_PostgreSQL | 0.6 |
| ps_MongoDB | 0.3 |
| ps_Linux | 0.3 |

Role skill to worker skill may be obtained, for example, using a table such as table 3, below.

TABLE 3

| | ps_Angular | ps_node.JS | ps_HTML5 | ps_PostgreSQL | ps_MongoDB | ps_Linux |
|---|---|---|---|---|---|---|
| rs_react.js | 0.8 | 0.8 | 0.8 | .05 | .05 | .0 |
| rs_mySQL | 0 | 0 | 0 | 0.7 | 0.3 | 0.1 |

Worker skill to worker skill proximity data may obtained using a table such as table 4, below.

TABLE 4

| | ps_Angular | ps_node.JS | ps_HTML5 | ps_PostgreSQL | ps_MongoDB | ps_Linux |
|---|---|---|---|---|---|---|
| . | 0 | 0.8 | 0.5 | 0.1 | 0.1 | 0.05 |
| ps_node.JS | 0.8 | 0 | 0.6 | 0.1 | 0.1 | 0.05 |
| ps_HTML5 | 0.5 | 0.6 | 0 | 0.1 | 0.1 | 0.05 |
| ps_PostgreSQL | 0.1 | 0.1 | 0.1 | 0 | 0.6 | 0.1 |
| ps_MongoDB | 0.1 | 0.1 | 0.1 | 0.6 | 0 | 0.05 |
| ps_Linux | 0.05 | 0.05 | 0.05 | 0.1 | 0.05 | 0 |

In some implementations, the skills fit system may generate a graph table from the data input described above. The graph table may indicate nodes, edges, and/or corresponding edge weights, among other examples. For example, the skills fit system may generate a table such as Table 5, shown below. In Table 5, each row indicates a pair of nodes (a source node and a target node) and an edge that connects the two nodes. The source node and target node columns in the table indicate what may be referred to as “local source nodes” and “local target nodes,” while the role node may be referred to as a “global source node” and the worker node may be referred to as a “global target node.” Local source nodes and local target nodes are so named to indicate a direction of flow along the edge that connects them (from source node to target node).

TABLE 5

| Edge Source | Edge Target | Edge Utility |
|---|---|---|
| ‘role’ | ‘rs_react.js’ | 1.000 |
| ‘role’ | ‘rs_mySQL’ | 1.000 |
| ‘rs_react.js’ | ‘ps_Angular’ | 0.800 |
| ‘rs_react.js’ | ‘ps_node.JS’ | 0.800 |
| ‘rs_react.js’ | ‘ps_HTML5’ | 0.800 |
| ‘rs_react.js’ | ‘ps_PostgreSQL’ | 0.050 |
| ‘rs_react.js’ | ‘ps_MongoDB’ | 0.050 |
| ‘rs_mySQL’ | ‘ps_PostgreSQL’ | 0.700 |
| ‘rs_mySQL’ | ‘ps_MongoDB’ | 0.300 |
| ‘rs_mySQL’ | ‘ps_Linux’ | 0.100 |
| ‘ps_Angular’ | ‘worker’ | 0.502 |
| ‘ps_node.JS’ | ‘worker’ | 0.147 |
| ‘ps_HTML5’ | ‘worker’ | 0.297′ |
| ‘ps_PostgreSQL’ | ‘worker’ | 0.438 |
| ‘ps_MongoDB’ | ‘worker’ | 0.195 |
| ‘ps_Linux’ | ‘worker’ | 0.260 |

The skills fit system may use the data of Table 5 to generate a weighted directed graph, as shown by the visual representation 300. The weighted directed graph may be, or include, a network of nodes and edges. As shown, the skills fit system may instantiate a role node as a source node 305 and a worker node as a target node 310. The skills fit system may instantiate role skill nodes 315 (shown as ‘rs_mySQL’ and ‘rs_react.js’) and worker skill nodes 320 (shown as ‘ps_Linux,’ ‘ps_MongoDB,’ ‘ps_PostgreSQL,’ ‘ps_node.JS,’ ‘ps_HTML5,’ and ‘ps_Angular’). The skills fit system may instantiate weighted directed edges between local source nodes and local target nodes, as shown. The edges depicted in the visual representation may be depicted as dashed lines, and the relative line thicknesses may represent the relative magnitude of the corresponding edge utility. For example, the edge 325 connecting the role skill node ‘rs react.js’ to the worker skill node ‘ps_Angular’ has an edge utility of 0.800 and is shown as being thicker than the edge 330 connecting the worker skill node ‘ps_Angular’ to the target node 310, which has an edge utility of 0.502.

The skills fit system may apply a max flow algorithm to the weighted directed graph to determine the maximum flow between the source node 305 and the target node 310, as described above. The skills fit system may determine edge flows between local source nodes and local target nodes, as indicated in Table 6, below. A maximum flow may be determined from the source node to the target node based at least in part on the edge flows.

TABLE 6

| Edge Source | Edge Target | Edge Utility | Edge Flow |
|---|---|---|---|
| ‘role’ | ‘rs_react.js’ | 1.000 | 0.945 |
| ‘role’ | ‘rs_mySQL’ | 1.000 | 0.733 |
| ‘rs_react.js’ | ‘ps_Angular’ | 0.800 | 0.502 |
| ‘rs_react.js’ | ‘ps_node.JS’ | 0.800 | 0.147 |
| ‘rs_react.js’ | ‘ps_HTML5’ | 0.800 | 0.297 |
| ‘rs_react.js’ | ‘ps_PostgreSQL’ | 0.050 | 0.000 |
| ‘rs_react.js’ | ‘ps_MongoDB’ | 0.050 | 0.000 |
| ‘rs_mySQL’ | ‘ps_PostgreSQL’ | 0.700 | 0.438 |
| ‘rs_mySQL’ | ‘ps_MongoDB’ | 0.300 | 0.195 |
| ‘rs_mySQL’ | ‘ps_Linux’ | 0.100 | 0.100 |
| ‘ps_Angular’ | ‘worker’ | 0.502 | 0.502 |
| ‘ps_node.JS’ | ‘worker’ | 0.147 | 0.147 |
| ‘ps_HTML5’ | ‘worker’ | 0.297′ | 0.297 |
| ‘ps_PostgreSQL’ | ‘worker’ | 0.438 | 0.438 |
| ‘ps_MongoDB’ | ‘worker’ | 0.195 | 0.195 |
| ‘ps_Linux’ | ‘worker’ | 0.260 | 0.100 |

As shown in FIG. 3B, the visual representation 300 of the weighted directed graph may be modified to represent the relative local maximum flows between local sources and local targets. For example, the visual representations of the edges may be made solid and may have relative thicknesses corresponding to relative magnitudes of maximum flow between local source nodes and local target nodes. The maximum flow of the network (which also may be referred to, interchangeably, as the “maximum flow of the graph”) may be determined by calculating the total flow out of the source node 305 or by calculating the total flow into the target node 310. In the example illustrated in FIGS. 3A and 3B, the maximum flow may be determined to be 1.678 by summing the flows corresponding to the two edges 335 and 340 connected to the source node 305.

In some implementations, as described above, the skills fit system also may identify skills gaps based at least in part on the weighted directed graph. For example, the skills fit system may identify a skills gap based at least in part on determining a ratio of an edge flow to the corresponding edge capacity and comparing the ratio to a threshold. In the illustrated example, the ratio of the edge flow to the edge capacity corresponding to the edge 335 connecting the source node 305 to the role skill node ‘rs_mySQL’ is 0.733. In some implementations, the skills fit system may compare this value to a threshold of 0.755, for example. Because 0.733 is less than 0.755, the skills fit system may identify a skills gap associated with the role skill ‘rs_mySQL.’ For example, the skills fit system may identify the role skill ‘rs_mySQL’ as being a skill that, if the worker were to develop greater proficiency in this skill (or in a proximal skill or skills), the fitness of the worker for the role would improve.

FIG. 4 is a diagram of an example environment 400 in which systems and/or methods described herein may be implemented. As shown in FIG. 4, environment 400 may include a skills fit system 401, which may include one or more elements of and/or may execute within a cloud computing system 402. The cloud computing system 402 may include one or more elements 403-413, as described in more detail below. As further shown in FIG. 4, environment 400 may include a network 420, a worker device 430 and/or an operator device 450. Devices and/or elements of environment 400 may interconnect via wired connections and/or wireless connections.

The cloud computing system 402 includes computing hardware 403, a resource management component 404, a host operating system 405, and/or one or more virtual computing systems 406. The resource management component 404 may perform virtualization (e.g., abstraction) of computing hardware 403 to create the one or more virtual computing systems 406. Using virtualization, the resource management component 404 enables a single computing device (e.g., a computer or a server) to operate like multiple computing devices, such as by creating multiple isolated virtual computing systems 406 from computing hardware 403 of the single computing device. In this way, computing hardware 403 can operate more efficiently, with lower power consumption, higher reliability, higher availability, higher utilization, greater flexibility, and lower cost than using separate computing devices.

Computing hardware 403 includes hardware and corresponding resources from one or more computing devices. For example, computing hardware 403 may include hardware from a single computing device (e.g., a single server) or from multiple computing devices (e.g., multiple servers), such as multiple computing devices in one or more data centers. As shown, computing hardware 403 may include one or more processors 407, one or more memories 408, one or more storage components 409, and/or one or more networking components 410. Examples of a processor, a memory, a storage component, and a networking component (e.g., a communication component) are described elsewhere herein.

The resource management component 404 includes a virtualization application (e.g., executing on hardware, such as computing hardware 403) capable of virtualizing computing hardware 403 to start, stop, and/or manage one or more virtual computing systems 406. For example, the resource management component 404 may include a hypervisor (e.g., a bare-metal or Type 1 hypervisor, a hosted or Type 2 hypervisor, or another type of hypervisor) or a virtual machine monitor, such as when the virtual computing systems 406 are virtual machines 411. Additionally, or alternatively, the resource management component 404 may include a container manager, such as when the virtual computing systems 406 are containers 412. In some implementations, the resource management component 404 executes within and/or in coordination with a host operating system 405.

A virtual computing system 406 includes a virtual environment that enables cloud-based execution of operations and/or processes described herein using computing hardware 403. As shown, a virtual computing system 406 may include a virtual machine 411, a container 412, or a hybrid environment 413 that includes a virtual machine and a container, among other examples. A virtual computing system 406 may execute one or more applications using a file system that includes binary files, software libraries, and/or other resources required to execute applications on a guest operating system (e.g., within the virtual computing system 406) or the host operating system 405.

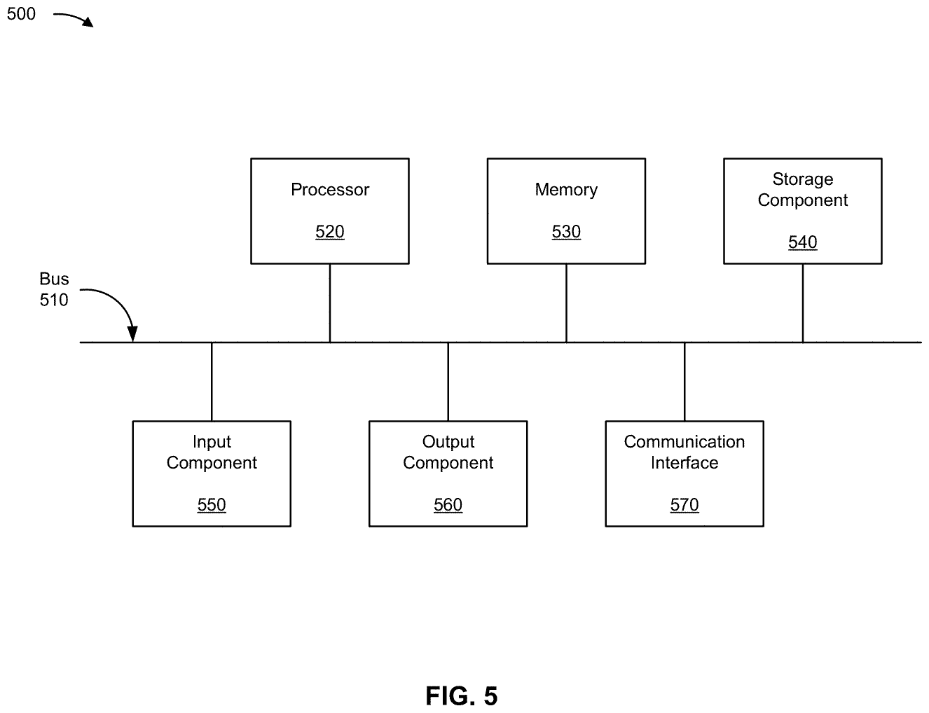

Although the skills fit system 401 may include one or more elements 403-413 of the cloud computing system 402, may execute within the cloud computing system 402, and/or may be hosted within the cloud computing system 402, in some implementations, the skills fit system 401 may not be cloud-based (e.g., may be implemented outside of a cloud computing system) or may be partially cloud-based. For example, the skills fit system 401 may include one or more devices that are not part of the cloud computing system 402, such as device 500 of FIG. 5, which may include a standalone server or another type of computing device. The skills fit system 401 may perform one or more operations and/or processes described in more detail elsewhere herein.

Network 420 includes one or more wired and/or wireless networks. For example, network 420 may include a cellular network, a public land mobile network (PLMN), a local area network (LAN), a wide area network (WAN), a private network, the Internet, and/or a combination of these or other types of networks. The network 420 enables communication among the devices of environment 400.

The worker device 430 may include a computing device that may be operable by a worker and may be configured to provide content to a worker, instantiate a learning component for the worker, and/or receive user input from a worker. The operator device may include a computing device operable by an operator and may be configured to provide content to an operator, receive user input from the operator, and/or the like. The skills data source 440 may include one or more sources of skills data. For example, the skills data source 440 may include a database.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500, which may correspond to skills fit system 401, a worker device 430, and/or an operator device 450. In some implementations, skills fit system 401, a worker device 430, and/or an operator device 450 may include one or more devices 500 and/or one or more components of device 500. As shown in FIG. 5, device 500 may include a bus 510, a processor 520, a memory 530, a storage component 540, an input component 550, an output component 560, and a communication component 570.

Bus 510 includes a component that enables wired and/or wireless communication among the components of device 500. Processor 520 includes a central processing unit, a graphics processing unit, a microprocessor, a controller, a microcontroller, a digital signal processor, a field-programmable gate array, an application-specific integrated circuit, and/or another type of processing component. Processor 520 is implemented in hardware, firmware, or a combination of hardware and software. In some implementations, processor 520 includes one or more processors capable of being programmed to perform a function. Memory 530 includes a random access memory, a read only memory, and/or another type of memory (e.g., a flash memory, a magnetic memory, and/or an optical memory).

Storage component 540 stores information and/or software related to the operation of device 500. For example, storage component 540 may include a hard disk drive, a magnetic disk drive, an optical disk drive, a solid state disk drive, a compact disc, a digital versatile disc, and/or another type of non-transitory computer-readable medium. Input component 550 enables device 500 to receive input, such as user input and/or sensed inputs. For example, input component 550 may include a touch screen, a keyboard, a keypad, a mouse, a button, a microphone, a switch, a sensor, a global positioning system component, an accelerometer, a gyroscope, and/or an actuator. Output component 560 enables device 500 to provide output, such as via a display, a speaker, and/or one or more light-emitting diodes. Communication component 570 enables device 500 to communicate with other devices, such as via a wired connection and/or a wireless connection. For example, communication component 570 may include a receiver, a transmitter, a transceiver, a modem, a network interface card, and/or an antenna.

Device 500 may perform one or more processes described herein. For example, a non-transitory computer-readable medium (e.g., memory 530 and/or storage component 540) may store a set of instructions (e.g., one or more instructions, code, software code, and/or program code) for execution by processor 520. Processor 520 may execute the set of instructions to perform one or more processes described herein. In some implementations, execution of the set of instructions, by one or more processors 520, causes the one or more processors 520 and/or the device 500 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 5 are provided as an example. Device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

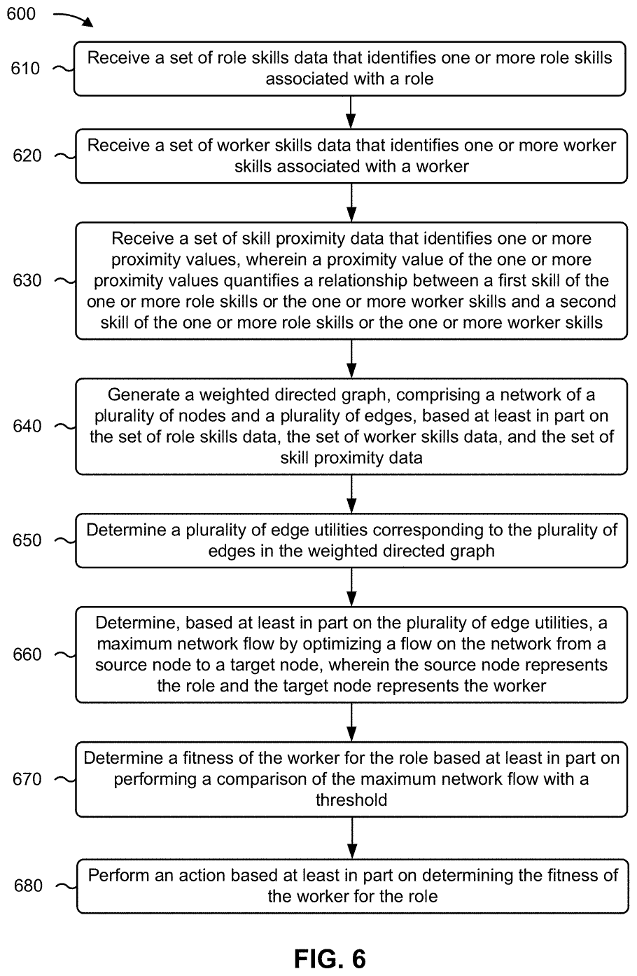

FIG. 6 is a flowchart of an example process 600 associated with skills fit management platform. In some implementations, one or more process blocks of FIG. 6 may be performed by a device (e.g., device 500). In some implementations, one or more process blocks of FIG. 6 may be performed by another device or a group of devices separate from or including the device, such as a worker device (e.g., worker device 430) and/or an operator device (e.g., operator device 450). Additionally, or alternatively, one or more process blocks of FIG. 6 may be performed by one or more components of device 500, such as processor 520, memory 530, storage component 540, input component 550, output component 560, and/or communication component 570.

As shown in FIG. 6, process 600 may include receiving a set of role skills data that identifies one or more role skills associated with a role (block 610). For example, the device may receive a set of role skills data that identifies one or more role skills associated with a role, as described above.

As further shown in FIG. 6, process 600 may include receiving a set of worker skills data that identifies one or more worker skills associated with a worker (block 620). For example, the device may receive a set of worker skills data that identifies one or more worker skills associated with a worker, as described above.

As further shown in FIG. 6, process 600 may include receiving a set of skill proximity data that identifies one or more proximity values, wherein a proximity value of the one or more proximity values quantifies a relationship between a first skill of the one or more role skills or the one or more worker skills and a second skill of the one or more role skills or the one or more worker skills (block 630). For example, the device may receive a set of skill proximity data that identifies one or more proximity values, wherein a proximity value of the one or more proximity values quantifies a relationship between a first skill of the one or more role skills or the one or more worker skills and a second skill of the one or more role skills or the one or more worker skills, as described above.

As further shown in FIG. 6, process 600 may include generating a weighted directed graph, comprising a network of a plurality of nodes and a plurality of edges, based at least in part on the set of role skills data, the set of worker skills data, and the set of skill proximity data (block 640). For example, the device may generate a weighted directed graph, comprising a network of a plurality of nodes and a plurality of edges, based at least in part on the set of role skills data, the set of worker skills data, and the set of skill proximity data, as described above.

As further shown in FIG. 6, process 600 may include determining a plurality of edge utilities corresponding to the plurality of edges in the weighted directed graph (block 650). For example, the device may determine a plurality of edge utilities corresponding to the plurality of edges in the weighted directed graph, as described above.

As further shown in FIG. 6, process 600 may include determining, based at least in part on the plurality of edge utilities, a maximum network flow by optimizing a flow on the network from a source node to a target node, wherein the source node represents the role and the target node represents the worker (block 660). For example, the device may determine, based at least in part on the plurality of edge utilities, a maximum network flow by optimizing a flow on the network from a source node to a target node, wherein the source node represents the role and the target node represents the worker, as described above.

As further shown in FIG. 6, process 600 may include determining a fitness of the worker for the role based at least in part on performing a comparison of the maximum network flow with a threshold (block 670). For example, the device may determine a fitness of the worker for the role based at least in part on performing a comparison of the maximum network flow with a threshold, as described above.

As further shown in FIG. 6, process 600 may include performing an action based at least in part on determining the fitness of the worker for the role (block 680). For example, the device may perform an action based at least in part on determining the fitness of the worker for the role, as described above.

Process 600 may include additional implementations, such as any single implementation or any combination of implementations described below and/or in connection with one or more other processes described elsewhere herein.

In a first implementation, process 600 includes determining an edge flow associated with an edge connecting the source node to a role skill node, determining a ratio of the edge flow to an edge utility of the edge connecting the source node to the role skill node, identifying a skills gap based at least in part on performing a comparison between the ratio and a skills threshold, and performing an action based at least in part on identifying the skills gap.

In a second implementation, alone or in combination with the first implementation, process 600 includes initiating, based at least in part on identifying the skills gap, a learning action associated with the skills gap.

In a third implementation, alone or in combination with one or more of the first and second implementations, the set of role skills data further identifies a relative importance, to performing the role, of a skill of the one or more skills associated with the role.

In a fourth implementation, alone or in combination with one or more of the first through third implementations, the set of worker skills data further identifies a proficiency level corresponding to a skill of the one or more skills associated with the worker.

In a fifth implementation, alone or in combination with one or more of the first through fourth implementations, generating the weighted directed graph comprises instantiating the plurality of nodes, wherein the plurality of nodes comprises the source node, the target node, a role skill node that represents the role skill, and a worker skill node that represents the worker skill.

In a sixth implementation, alone or in combination with one or more of the first through fifth implementations, generating the weighted directed graph further comprises instantiating the plurality of edges, wherein the plurality of edges comprises a first edge between the source node and a role skill node, a second edge between the role skill node and a worker skill node, and a third edge between the worker skill node and the target node.

In a seventh implementation, alone or in combination with one or more of the first through sixth implementations, an edge utility corresponding to the second edge comprises the proximity value.

In an eighth implementation, alone or in combination with one or more of the first through seventh implementations, the proximity value is based at least in part on a distance metric that characterizes a distance between a vector representation of the role skill and a vector representation of the worker skill.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving a set of role skills data that identifies one or more role skills associated with a role;
receiving a set of worker skills data that identifies one or more worker skills associated with a worker;
receiving a set of skill proximity data that identifies one or more proximity values, wherein a proximity value of the one or more proximity values quantifies a relationship between a first skill of the one or more role skills or the one or more worker skills and a second skill of the one or more role skills or the one or more worker skills;
generating a weighted directed graph, comprising a network of a plurality of nodes and a plurality of edges, based at least in part on the set of role skills data, the set of worker skills data, and the set of skill proximity data;
determining a plurality of edge utilities corresponding to the plurality of edges in the weighted directed graph;
determining, based at least in part on the plurality of edge utilities, a maximum network flow by optimizing a flow on the network from a source node to a target node, wherein the source node represents the role and the target node represents the worker;
determining a fitness of the worker for the role based at least in part on performing a comparison of the maximum network flow with a threshold; and
performing an action based at least in part on determining the fitness of the worker for the role.

2. The method of claim 1, further comprising:
determining an edge flow associated with an edge connecting the source node to a role skill node;
determining a ratio of the edge flow to an edge utility of the edge connecting the source node to the role skill node;
identifying a skills gap based at least in part on performing a comparison between the ratio and a skills threshold; and
performing an action based at least in part on identifying the skills gap.

3. The method of claim 2, further comprising initiating, based at least in part on identifying the skills gap, a learning action associated with the skills gap.

4. The method of claim 1, wherein the set of role skills data further identifies a relative importance, to performing the role, of a skill of the one or more skills associated with the role.

5. The method of claim 1, wherein the set of worker skills data further identifies a proficiency level corresponding to a skill of the one or more skills associated with the worker.

6. The method of claim 1, wherein generating the weighted directed graph comprises:
instantiating the plurality of nodes, wherein the plurality of nodes comprises:
the source node,
the target node,
a role skill node that represents the role skill, and
a worker skill node that represents the worker skill.

7. The method of claim 6, wherein generating the weighted directed graph further comprises instantiating the plurality of edges, wherein the plurality of edges comprises:
a first edge between the source node and a role skill node,
a second edge between the role skill node and a worker skill node, and
a third edge between the worker skill node and the target node.

8. The method of claim 7, wherein an edge utility corresponding to the second edge comprises the proximity value.

9. The method of claim 1, wherein the proximity value is based at least in part on a distance metric that characterizes a distance between a vector representation of the role skill and a vector representation of the worker skill.

10. A device, comprising:
one or more memories; and
one or more processors, communicatively coupled to the one or more memories, configured to:
receive a set of role skills data that identifies one or more role skills associated with a role;
receive a set of worker skills data that identifies one or more worker skills associated with a worker;
receive a set of skill proximity data that identifies one or more proximity values, wherein a proximity value of the one or more proximity values quantifies a relationship between a first skill of the one or more role skills or the one or more worker skills and a second skill of the one or more role skills or the one or more worker skills;
generate a weighted directed graph, comprising a network of a plurality of nodes and a plurality of edges, based at least in part on the set of role skills data, the set of worker skills data, and the set of skill proximity data;
determine a plurality of edge utilities corresponding to the plurality of edges in the weighted directed graph;
determine, based at least in part on the plurality of edge utilities, a maximum network flow by optimizing a flow on the network from a source node to a target node, wherein the source node represents the role and the target node represents the worker;
determine a fitness of the worker for the role based at least in part on performing a comparison of the maximum network flow with a threshold; and
perform an action based at least in part on determining the fitness of the worker for the role.

11. The device of claim 10, wherein the one or more processors are further configured to:
determine an edge flow associated with an edge connecting the source node to a role skill node;
determine a ratio of the edge flow to an edge utility of the edge connecting the source node to the role skill node;
identify a skills gap based at least in part on performing a comparison between the ratio and a skills threshold; and
performing an action based at least in part on identifying the skills gap.

12. The device of claim 11, herein the one or more processors, when performing the action, are configured to initiate, based at least in part on identifying the skills gap, a learning action associated with the skills gap.

13. The device of claim 11, wherein the one or more processors, when performing the action, are configured to facilitate display, on a display device, of an indication of at least one of the fitness of the worker for the role or the skills gap.

14. The device of claim 10, wherein the set of role skills data further identifies a relative importance, to performing the role, of a skill of the one or more skills associated with the role.

15. The device of claim 10, wherein the set of worker skills data further identifies a proficiency level corresponding to a skill of the one or more skills associated with the one or more workers.

16. The device of claim 10, wherein the one or more processors, when generating the weighted directed graph, are configured to:
instantiate the plurality of nodes, wherein the plurality of nodes comprises:
the source node,
the target node,
a role skill node that represents the role skill, and
a worker skill node that represents the worker skill ; and
instantiate the plurality of edges, wherein the plurality of edges comprises:
a first edge between the source node and a role skill node,
a second edge between the role skill node and a worker skill node, and
a third edge between the worker skill node and the target node .

17. A non-transitory computer-readable medium storing a set of instructions, the set of instructions comprising:
one or more instructions that, when executed by one or more processors of a device, cause the device to:
receive a set of role skills data that identifies one or more role skills associated with a role;
receive a set of worker skills data that identifies one or more worker skills associated with a worker;
receive a set of skill proximity data that identifies one or more proximity values, wherein a proximity value of the one or more proximity values quantifies a relationship between a first skill of the one or more role skills or the one or more worker skills and a second skill of the one or more role skills or the one or more worker skills;
generate a weighted directed graph, comprising a network of a plurality of nodes and a plurality of edges, based at least in part on the set of role skills data, the set of worker skills data, and the set of skill proximity data;
determine a plurality of edge utilities corresponding to the plurality of edges in the weighted directed graph;
determine, based at least in part on the plurality of edge utilities, a maximum network flow by optimizing a flow on the network from a source node to a target node, wherein the source node represents the role and the target node represents the worker;
determine a fitness of the worker for the role based at least in part on performing a comparison of the maximum network flow with a threshold; and
perform an action based at least in part on determining the fitness of the worker for the role.

18. The non-transitory computer-readable medium of claim 17, wherein the one or more instructions further cause the device to:
determine an edge flow associated with an edge connecting the source node to a role skill node;
determine a ratio of the edge flow to an edge utility of the edge connecting the source node to the role skill node; and
identify a skills gap based at least in part on performing a comparison between the ratio and a skills threshold.

19. The non-transitory computer-readable medium of claim 18, wherein the one or more instructions further cause the device to facilitate, based at least in part on identifying the skills gap, initiation of a learning action associated with the skills gap.

20. The non-transitory computer-readable medium of claim 17, wherein an edge utility corresponding to an edge connecting a role skill node to a worker skill node comprises the proximity value, and wherein the proximity value is based at least in part on a distance metric that characterizes a distance between a vector representation of the role skill and a vector representation of the worker skill.
